(19) United States
(12) Patent Application Publication
(10) Pub. No.: US 2025/0148196 A1
(43) Pub. Date: May 8, 2025

(54) AI ENHANCED PDF CONVERSION INTO HUMAN READABLE AND MACHINE PARSABLE HTML

(71) Applicant: MORNINGSTAR INC., Chicago, IL (US)

(72) Inventors: Hu CHEN, Shenzhen (CN); Xin WEN, Shenzhen (CN); Wenliang HE, Shenzhen (CN); Ming LU, Shenzhen (CN); Shariq AHMAD, Chicago, IL (US)

(21) Appl. No.: 18/726,905

(22) PCT Filed: Jan. 9, 2023
(86) PCT No.: PCT/US2023/010437

§ 371 Date: Jul. 5, 2024

(30) Foreign Application Priority Data
Jan. 10, 2022 (CN) 202210022655.3

(51) Int. Cl. G06F 40/169; G06F 40/151

(52) U.S. Cl. CPC G06F 40/169; G06F 40/151

(57) ABSTRACT

Computer implemented method for converting PDF documents into human readable and machine parsable HTML code. The method includes the use of a machine learning algorithm in order to automatically annotate the HTML code, said algorithm being trained with a set of manually annotated HTML code examples.

### FIELD OF THE INVENTION

The present invention relates to methods of processing digital documents. In particular, the present invention relates to methods of format conversion of digital documents.

### BACKGROUND

PDF (Portable Document Format) is a prevalent file storage format in that PDF files cannot be modified but can be conveniently shared and printed. While PDF files can be easily read by humans, computers cannot readily ingest raw PDF files for subsequent information processing. As a result, PDF files need to be converted into other formats that are more conducive to programmatic parsing, which is crucially important in the age of artificial intelligence that is particularly keen for more data.

DE102006025928 discloses a computerized method for converting portable documents format document into hypertext markup language document. The method includes the steps of extracting images, their dimensions and positions contained in the code of a PDF document, the storing of said images, the conversion of text contained in the same PDF into HTML and the parsing of the images and text.

US20120137207 describes methods and systems for processing and converting PDF files into machine readable file formats. However, these method do not aim specifically at the conversion of PDF files. Furthermore, these methods resort to iterative aggregation in order to attain a final separation of images, text and tables.

While the methods disclosed above are able to convert a PDF document to HTML, the inclusion of HTML annotation is still not optimal, which often results in poor presentation of the converted document. Furthermore, converted HTML files are often poorly tagged, resulting in poor searchability and document content continuity.

The aim of the invention is to provide a method which eliminates those disadvantages. Accordingly, a need arises for a method capable of converting PDF files into HTML files having high conversion fidelity, presentation and searchability.

### SUMMARY OF THE INVENTION

The present invention and embodiments thereof serve to provide a solution to one or more of above-mentioned disadvantages. To this end, the present invention relates to a computer implemented method for converting PDF documents into human readable and machine parsable HTML code according to claim 1. Preferred embodiments of the device are shown in any of the claims 2 to 13.

In a second aspect, the present invention relates to a computer system for improved PDF to human readable and machine parsable HTML conversion according to claim 14. This system according to this aspect permits the implementation of the method of claim 1 in a simple and efficient manner.

In a third aspect the present invention relates to a use, according to claim 15, of the computer-implemented method of claim 1 by means of the computer system of claim 14 for converting PDF into human readable and machine parsable HTML.

### DESCRIPTION OF FIGURES

The following description of the figures of specific embodiments of the invention is merely exemplary in nature and is not intended to limit the present teachings, their application or uses. Throughout the drawings, corresponding reference numerals indicate like or corresponding parts and features.

FIG. 1 shows the architecture is an end-to-end fully convolutional network composed of two consecutive parts.

FIG. 2 shows a first example of the application of the segmentation algorithm.

FIG. 3 shows a second example of the application of the segmentation algorithm.

FIG. 4 shows a first target paragraph presented at the top of a column.

FIG. 5 shows a second example of paragraph sequencing where a second target paragraph is presented at the bottom of the first column.

FIG. 6 shows an example of overlap between ground truth and prediction.

### DETAILED DESCRIPTION OF THE INVENTION

The present invention concerns a computer implemented method for converting PDF documents into human readable and machine parsable HTML code.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The recitation of numerical ranges by endpoints includes all numbers and fractions subsumed within that range, as well as the recited endpoints.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. The terms or definitions used herein are provided solely to aid in the understanding of the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In a first aspect, the invention provides/relates to a computer implemented method for converting PDF documents into human readable and machine parsable HTML code comprising the steps of:
a. extracting texts;
b. extracting formatting styles;
c. extracting background graphs;
d. extracting positional info;
e. extracting font family information;
f. annotating of html code;
g. organizing reading order and;
h. including metadata;
   the method includes the use of a machine learning algorithm to automatically annotate HTML code, which machine learning algorithm is trained with a set of manually annotated HTML code examples.

In a preferred embodiment, the extracted font family information is True Type Fonts compatible. This advantageously permits that extracted font-family can be correctly rendered by regular web browsers. Successful extraction of all PDF elements would hence give identical looks between the original PDFs and converted HTMLs.

In a further or another text within a paragraph is annotated with <span></span> tags. By HTML convention, the <span> tags have a special property such that web browsers treat texts from adjacent pairs of <span> tags as if they belong to one single sentence. For example, <span> this is </span><span> an example </span> is considered functionally identical to <span> this is an example </span>. As a consequence, after segments of texts from the same paragraph are placed within consecutive pairs of <span> tags instead of <div> tags, search operations can be advantageously carried out for longer string of text. Said string of text can span across multiple rows with not detriment to the searchability of the text. This is because, regardless of the number of <span></span> pairs used to chunk up a long paragraph, the result is identical to using only one pair of <span></span> tags, where the first tag is placed at the beginning of the paragraph and the second tag by the end.

In a further or another embodiment, each paragraph is annotated such that it is contained between <div></div> tags. In this way, division of a document is made substantially easier which permits easier development of the layout of the document.

In a further or another embodiment, tables are annotated with <tr></tr> only for rows and <td></td> only for table cells. This permits maintaining a high level of code consistency that advantageously permits attaining a presentation of the converted document, which presentation remains faithful to the original PDF document. Furthermore, by maintaining such high level of consistency, smooth searchability of the converted document is advantageously ensured.

PDF documents often contain a plurality of presentations which make the establishing of reading order particularly challenging. More in particular, texts presented in the form of multiple columns per page require additional care in order to maintain a readable text after conversion. To this end, in a further or another embodiment organizing of the reading order is determined based on a combination of:
a. innate reading order;
b. region delineation by a segmentation algorithm; and
c. paragraph sequencing.

Whether the text is divided into columns or not, most of said text is already serialized in the right sequence. Therefore, this innate reading order is used as a first stage in organizing the reading order and as a first advantageous clue for the next steps.

In order to delineate regions within a page, a segmentation algorithm is used. Once more, this step is particularly relevant where the text is presented in columns as the algorithm advantageously permits identifying said columns. In a further or another embodiment, the segmentation algorithm used is U-Net. the architecture is an end-to-end fully convolutional network composed of two consecutive parts. The first part is a contracting encoder where the length and width of an image are continuously halved via convolution and max pooling several times down to a much smaller feature map to capture the context in the image. The second part is an expanding decoder in reverse where the dimensions of the feature map are continuously doubled back to its original size via up-sampled convolution to enable precise localization of pixels responsible for segmenting the image. The output of U-Net is another image of the same size to the original image, composed solely of zeros and ones. Pixels of ones form irregularly shaped bands. After some post-processing, bands would give rise to lines that delineate regions of a page. In some embodiments, the process of paragraph sequencing can be used as an alternative to the a segmentation algorithm. More preferably, the paragraph sequencing process is used after a segmentation algorithm.

In a further or another embodiment, the process of paragraph sequencing comprises the steps of:
a. selecting a number of candidate paragraphs, said candidate paragraphs being adjacent to a target paragraph or at the top of the subsequent text column;
b. pairing each candidate paragraph with the target paragraph;
c. assessing each pair for fit;
d. choosing the pair with the best fit;

By preference, the fit of each pair of target paragraph and candidate paragraph is assessed using language models. In this way, paragraphs can be effectively serialized even when the original text is presented in the form of columns.

In a further or another embodiment, the metadata included in the converted file includes tables, graphs, headings, page headers and footers. This advantageously permits the inclusion rich metadata upon conversion.

By preference, tables and graphs are detected by means of an object recognition algorithm. By preference, the object detection algorithm is YOLO 5. YOLO5 is an efficient algorithm for object detection in that it performs classification and draws bounding box at the same time. The performance of object detection algorithms can be assessed by several metrics. A preferred metric is Intersection Over Union (IOU). This metric is defined by the ratio of area of overlap over the union of ground truth and prediction. By preference a two-stage evaluation scheme is used, said evaluation scheme being based on the concept of IOU.

Stage one evaluates the overall hit rate of the predicative bounding boxes, where a hit is accounted if the IOU of a prediction box is over at least 0.75; otherwise the prediction is a miss or a false positive. Hence, stage-one precision is the rate of the number of true hits over the number of all predictions and stage-one recall is the rate of number of true hits over the number of all true objects. Stage-one is the geometric mean of the corresponding precision and recall.

In contrast, stage two evaluates the quality of a prediction given it is a true hit. Stage-two precision is the ratio of the overlap area over the prediction area. Stage-two recall is the ratio of the overlap area over the area of ground truth. Stage-two score is the corresponding geometric mean of precision and recall.

In a further or another embodiment, headings are identified based of differences in font styles between headings and regular text. In a further or another embodiment, page headers and footers are identified based on text and text location similarity. This advantageously reduce the computational power necessary to process elements exhibiting high levels of repetition throughout the document.

A second aspect of the invention relates to a computer system for improved PDF to human readable and machine parsable HTML conversion, the computer system configured for performing the computer-implemented method described above.

A third aspect of the invention pertains to the use of the computer-implemented method described above by means of the above described computer system for converting PDF into human readable and machine parsable HTML.

The invention is further described by the following non-limiting examples which further illustrate the invention, and are not intended to, nor should they be interpreted to, limit the scope of the invention.

### DESCRIPTION OF FIGURES

With as a goal illustrating better the properties of the invention the following presents, as an example and limiting in no way other potential applications, a description of a number of preferred embodiments of the invention, wherein:

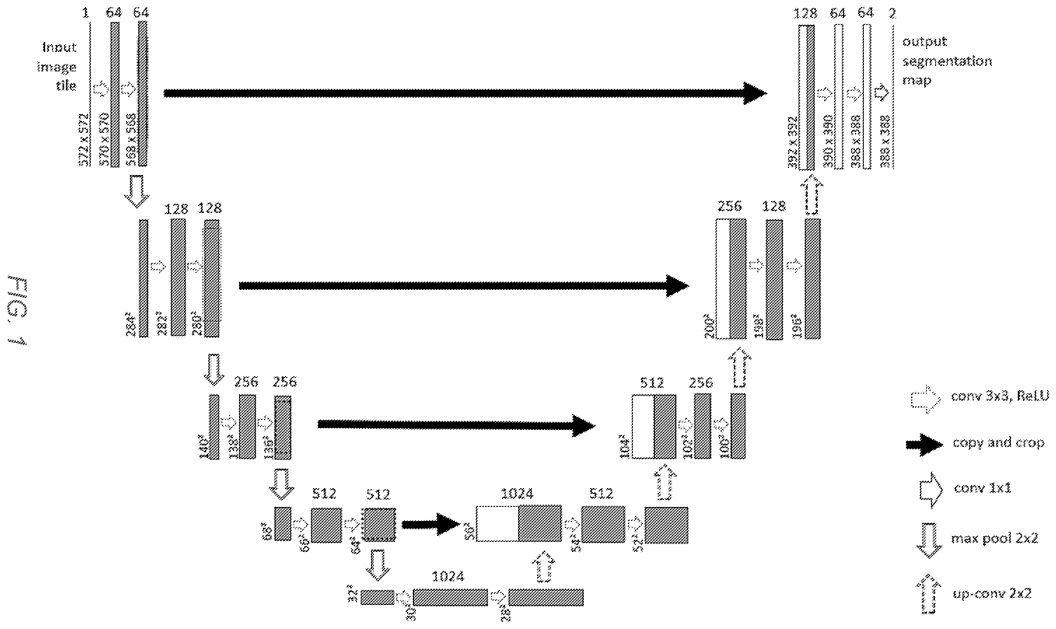

FIG. 1 shows the architecture is an end-to-end fully convolutional network composed of two consecutive parts. The first part is a contracting encoder where the length and width of an image are continuously halved via convolution and max pooling several times down to a much smaller feature map to capture the context in the image. The second part is an expanding decoder in reverse where the dimensions of the feature map are continuously doubled back to its original size via up-sampled convolution to enable precise localization of pixels responsible for segmenting the image. Since the contracting part is symmetric to the expanding part, it yields a U-shaped architecture.

The present invention will now be further exemplified with reference to the following examples. The present invention is in no way limited to the given examples or to the embodiments presented in the figures.

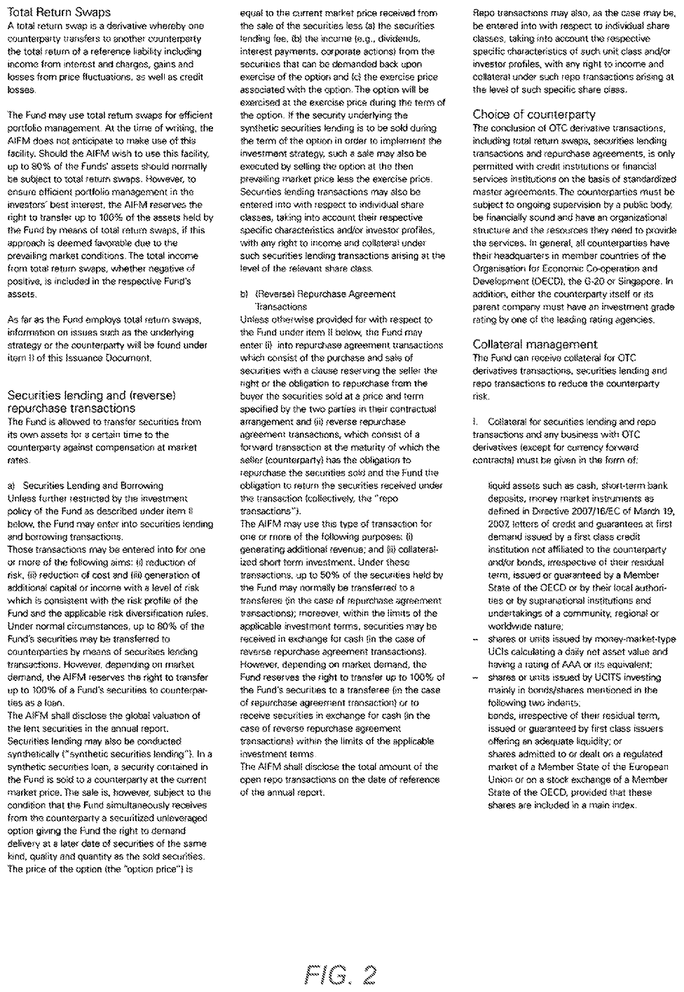

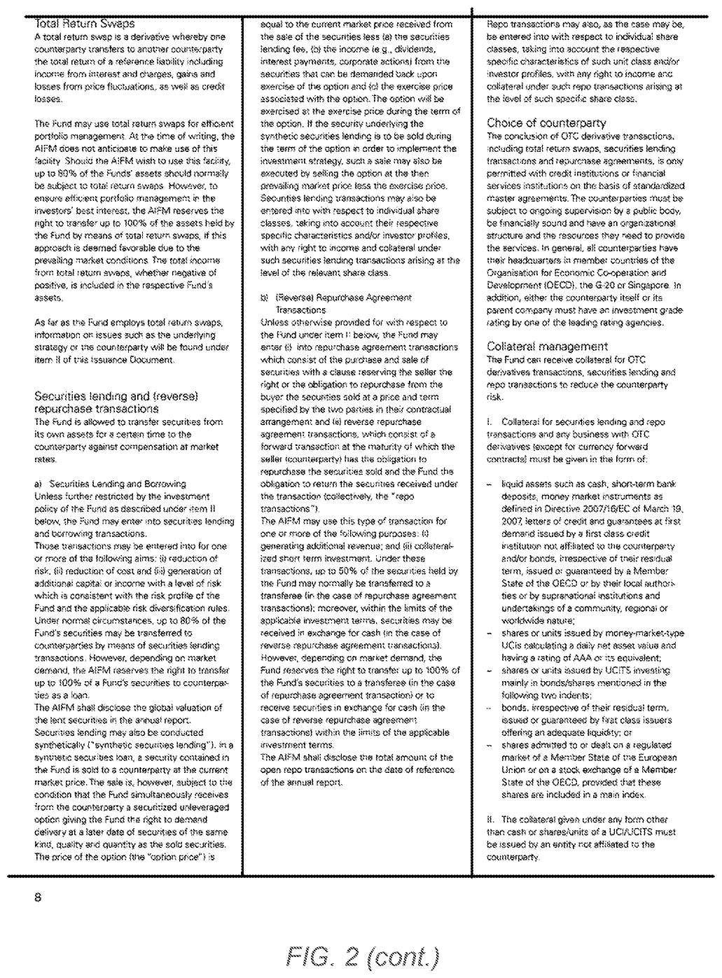

FIG. 2 shows a first example of the application of the segmentation algorithm. A first image is shown and then an output image is shown after having been processed by the segmentation algorithm. The output image is the same size to the original image, composed solely of zeros and ones. During processing pixels of “ones” form irregularly shaped bands which, after some post-processing, give rise to lines that delineate regions of a page. The images shown in this example demonstrate the result of processing a page comprising three columns of text.

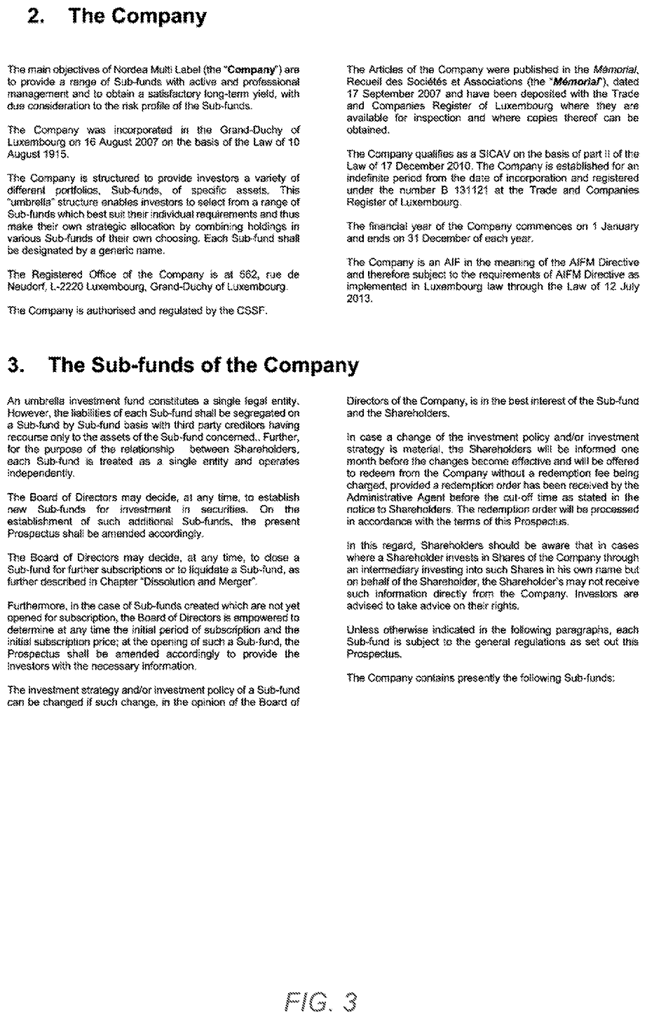

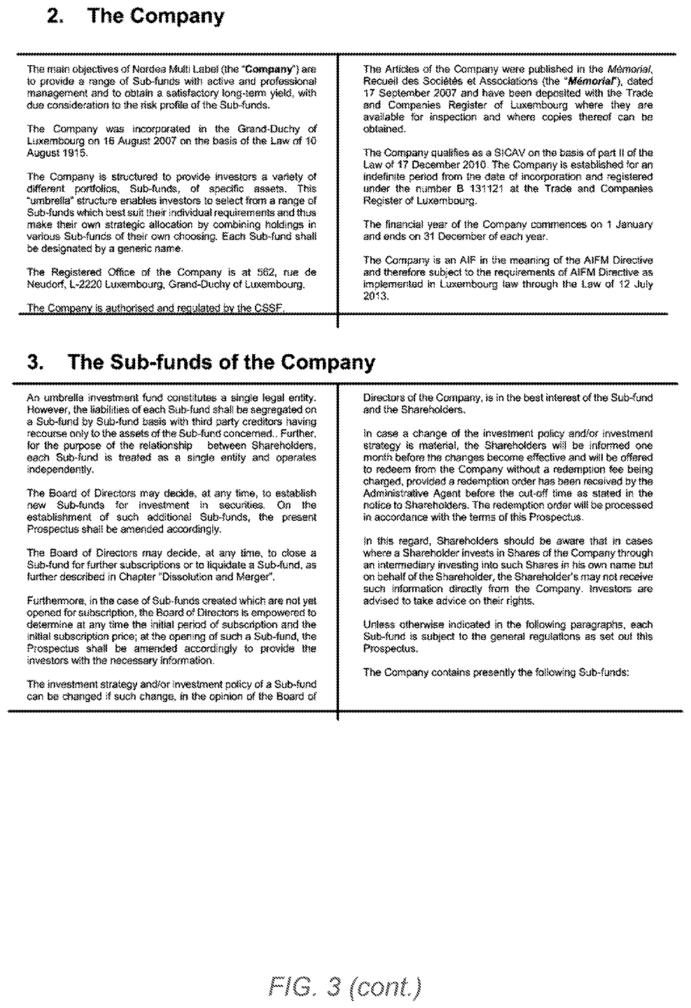

FIG. 3 shows a second example of the application of the segmentation algorithm.

An image is shown and then an output image is shown of the picture after having been processed by the segmentation algorithm. The images shown in this example demonstrate the result of processing a page comprising two pairs of columns of text separated by a heading.

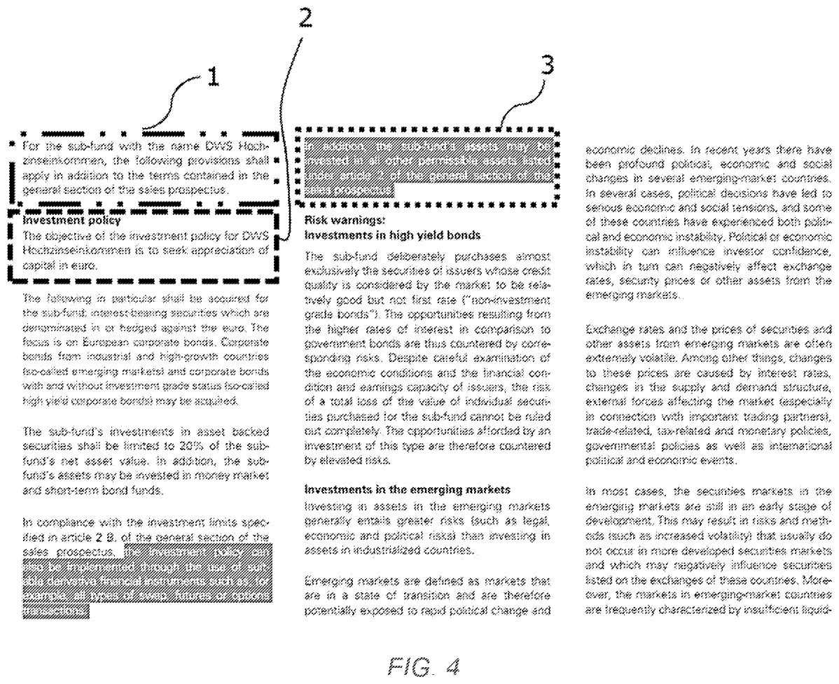

FIG. 4 shows a first target paragraph 1 presented at the top of a column. The figure shows a number of candidate paragraphs 2 and 3, which paragraphs are adjacent to the first target paragraph 1.

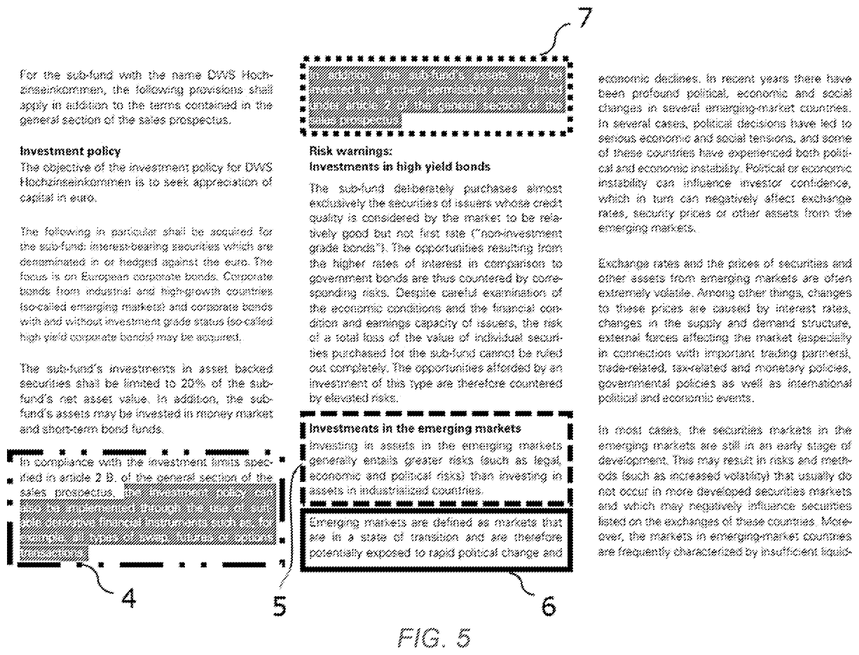

FIG. 5 shows a second example of paragraph sequencing where a second target paragraph 4 is presented at the bottom of the first column. In this figure, the candidate paragraphs 5, 6 and 7 are not only the ones adjacent to the second target paragraph but also the paragraph at the top of the next column.

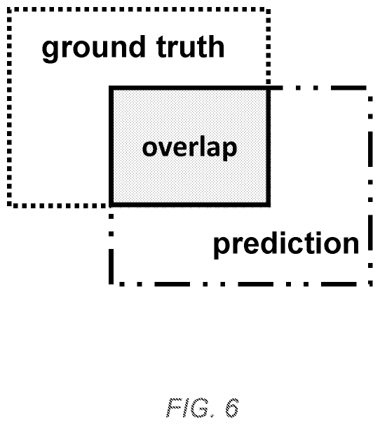

FIG. 6 shows an example of overlap between ground truth and prediction. The ground truth is represented by a first square while prediction by a second square. Larger overlap between ground truth and prediction indicates better performance. Intersection Over Union (IOU) is defined by the ratio of area of overlap over the union of ground truth and prediction.

### LIST OF NUMBERED ITEMS

1 first target paragraph
2 first candidate paragraph to first target paragraph
3 second candidate paragraph to first target paragraph
4 second target paragraph
5 first candidate paragraph to second target paragraph
6 second candidate paragraph to second target paragraph
7 third candidate paragraph to second target paragraph

It is supposed that the present invention is not restricted to any form of realization described previously and that some modifications can be added to the presented example of fabrication without reappraisal of the appended claims.

The present invention is in no way limited to the embodiments described in the examples and/or shown in the figures. On the contrary, methods according to the present invention may be realized in many different ways without departing from the scope of the invention.

1. A computer-implemented method for converting PDF documents into human readable and machine parsable HTML code comprising the steps of:
extracting texts;
extracting formatting styles;
extracting background graphs;
extracting positional info;
extracting font family information;
annotating of html code;
organizing reading order; and
including metadata;
characterized in that, a machine learning algorithm is used to automatically annotate HTML code, which machine learning algorithm is trained with a set of manually annotated HTML code examples, the extracted font family information is True Type Fonts compatible, organizing of the reading order is determined based on a combination of:
innate reading order;
region delineation by a segmentation algorithm; and
paragraph sequencing;
text within a paragraph is annotated with <span></span> tags.

2. The method according to claim 1, characterized in that, each paragraph is annotated such that it is contained between <div></div> tags.

3. The method according to claim 1, characterized in that, tables are annotated with <tr></tr> only for rows and <td></td> only for table cells.

4. The method according to claim 1, the segmentation algorithm is a U-Net algorithm.

5. The method according to claim 1, characterized in that, the paragraph sequencing comprises the steps of:
selecting a number of candidate paragraphs, the number of candidate paragraphs being adjacent to a target paragraph or at a top of a subsequent text column;
pairing each candidate paragraph with the target paragraph;
assessing each pair for fit; and
choosing a pair with a best fit.

6. The method according to claim 5, characterized in that, the fit of each pair of target paragraph and candidate paragraph is assessed using language models.

7. The method according to claim 1, characterized in that, the metadata included in a converted file includes tables, graphs, headings, page headers and footers.

8. The method according to claim 1, characterized in that, tables and graphs are detected by means of an object recognition algorithm.

9. The method according to claim 1, characterized in that, headings are identified based of differences in font styles between headings and regular text.

10. The method according to claim 1, characterized in that, page headers and footers are identified based on text and text location similarity.

11. A computer system for improved PDF to human readable and machine parsable HTML conversion, the computer system configured for performing the computer-implemented method according to claim 1.

12. Use of the computer-implemented method according to claim 1, for converting PDF into human readable and machine parsable HTML.

13.-15. (canceled)
